(19) United States
(12) Patent Application Publication
(10) Pub. No.: US 2022/0388241 A1
(43) Pub. Date: Dec. 8, 2022

(54) Use of Multi-Axis Magnetic fields in Orienting Material Property Enhancing Fibers, including for Strengthening and Joining purposes, in Additive Manufacturing Processes

(71) Applicant: United States of America, as represented by the Secretary of the Navy, Patuxent River, MD (US)

(72) Inventor: Frank Yelinek, Mechanicsville, MD (US)

(21) Appl. No.: 17/337,469

(22) Filed: Jun. 3, 2021

(51) Int. Cl. B29C 64/194; B33Y 10/00; B33Y 30/00; B33Y 50/02; B22F 10/85; B22F 10/10; B29C 64/165; B22F 10/50; B29C 64/393

(52) U.S. Cl. CPC B29C 64/194; B33Y 10/00; B33Y 30/00; B33Y 50/02; B22F 10/85; B22F 10/10; B29C 64/165; B22F 10/50; B29C 64/393

(57) ABSTRACT

An apparatus and method to magnetically align fibers in a base additive material during an additive manufacturing process for material property enhancing purposes or to facilitate joining of multiple types of materials during the additive process to form an integrated part. The magnetically alignable fibers are positioned through the application of a controlled, multi-axis positioning magnetic field during the additive-material layer deposition phase. This allows the fibers to be embedded within the base additive-material in any three-dimensional desired orientation, and the orientation to be varied from layer to layer, to permit directional enhancement of material properties, dependent on the nature of the fiber materials themselves. Likewise, joining of multiple types of materials may be improved through the controlled deposition of such fibers embedded within the base material itself during the additive-process between layers of two or more dissimilar materials, to provide a directionally aligned mechanical attachment between layers of base additive materials to result in a strengthened consolidated part at the conclusion of the additive manufacturing process.

### STATEMENT OF GOVERNMENT INTEREST

The invention described herein may be manufactured and used by or for the Government of the United States of America for governmental purposes without payment of any royalties thereon or therefor.

### BACKGROUND

Additive manufacturing (AM) or three-dimensional (3D) printing refers to a process for making three-dimensional objects of virtually any shape from 3D model data. Additive manufacturing is achieved using a process of joining materials to make objects from 3D model data, typically layer upon layer, instead of by conventional subtractive, molding, forging, or extrusion methods.

Various techniques may be used in an additive manufacturing process. ISO/ASTM52900-15 defines seven categories of AM processes: Binder Jetting, Directed Energy Deposition, Material Extrusion, Material Jetting, Powder Bed Fusion, Sheet Lamination and Vat Photopolymerization. Material extrusion, for example, involves heating a material such as a thermoplastic or a metal, extruding it from a printer head and depositing it in successive layers to form a three-dimensional solid; powder bed fusion or granular material binding, selectively melts or sinters a bed of base material by directing a laser beam or an electron beam onto a granular bed of fusable material to form a solid; and vat photopolymerization uses a bath of liquid photosensitive polymer that is hardened layer by layer into a solid by selective exposure to ultraviolet radiation.

Although additive manufacturing opens many new opportunities for fabrication of items and components, a number of materials-related problems have limited its applicability. While additive manufacturing systems can fabricate objects from a variety of plastics, metals, and ceramics, the fabrication of an object by successive layering can introduce structural weaknesses in many materials or may not provide sufficient or efficient structural or other desired properties. For example, when some materials are layered in an additive manufacturing process, there can be inconsistent bond quality and poor through-thickness properties, rendering the process unsuitable for applications where high performance, mechanical strength and thermal resistance, are necessary. There is also a trade-off between the material properties necessary for the end application of the item being created, and those necessary to accommodate the additive manufacturing process being utilized. Embodiments according to the present invention are intended to address these concerns as well as to provide new possibilities for fabrication, assembly, strength and other property enhancements of materials and components created using additive manufacturing.

### SUMMARY

A method and apparatus for additive manufacturing of a fiber enhanced composite object are disclosed. In one aspect, the method includes depositing a plurality of magnetically alignable fibers with an additive manufacturing base material onto a substrate to form a layer of fiber enhanced composite, providing a magnetic field source to align the magnetically alignable fibers in a predetermined three-dimensional orientation in the additive manufacturing base material to enhance a physical property of the fiber enhanced composite, and fusing the magnetically aligned fibers and the additive manufacturing base material to the substrate. In another aspect, the method for additive manufacturing of a fiber enhanced composite object provides that depositing a plurality of magnetically alignable fibers includes forming a spatial variation in the density of the fibers along one or more axes in the additive manufacturing base material. In another aspect, the predetermined orientation of the fibers compensates for a structural weakness in the object. In another further aspect, the structural weakness in the object compensated for by the fibers includes a structural weakness at an interface between layers of dissimilar base materials applied during the additive manufacturing process.

In another aspect, the apparatus for depositing an additive manufacturing material together with a number of magnetically alignable fibers includes an additive manufacturing deposition head positioned over a worktable to deposit layers of the additive manufacturing material on a substrate, a magnetic alignment head positioned over the worktable and oriented to provide a magnetic field to align the magnetically alignable fibers in a pre-determined three-dimensional orientation in the layers of additive manufacturing material and a controller for modulating the magnetic field to effect the predetermined alignment of the magnetically alignable fibers in the layer of additive manufacturing material. In yet another aspect, the controller includes a feedback control circuit. In another further aspect, the feedback control circuit includes a sensor to determine the orientation of magnetically alignable fibers and provides information to the feedback control circuit to correct the fiber orientation during the fiber deposition process.

Other aspects, features, and advantages of the present invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### DRAWINGS

FIG. 1 is a simplified block diagram of an additive manufacturing system according to a first representative embodiment of the present invention having a magnetic alignment head co-axially mounted with one or more deposition head nozzles.

FIG. 2 is a simplified block diagram of a second embodiment of an additive manufacturing system according to an alternative embodiment of the present invention in which magnetic alignment head is separated from the one or more deposition head nozzles.

FIG. 3A shows a first process step of an exemplary additive manufacturing process of an embodiment according to the present invention.

FIG. 3B shows a second process step of an exemplary additive manufacturing process according to an embodiment of the present invention.

FIG. 3C shows a third process step of an exemplary additive manufacturing process according to an embodiment of the present invention.

FIG. 4 shows a perspective view of a first alternative configuration of a property enhancing magnetic fiber for use in embodiments according to the present invention.

FIG. 5 shows a sectional perspective view of the configuration of a fiber illustrated in FIG. 4.

FIG. 6 shows a perspective view of a second alternative configuration of a property enhancing magnetic fiber for use in embodiments according to the present invention.

FIG. 7 shows a sectional perspective view of the configuration of a fiber illustrated in FIG. 6.

FIG. 8 shows a close up of a co-axially mounted magnetic alignment head in operation, aligning fibers during deposition, as part of an exemplary additive manufacturing process according to an embodiment of the present invention.

FIG. 9 and FIG. 10 show perspective and sectional views, respectively, of magnetically aligned property enhancing fibers joining layers of materials as part of an exemplary additive manufacturing process according to an embodiment of the present invention.

### DESCRIPTION

In the following detailed description of the preferred embodiments, reference is made to the accompanying drawings which form a part hereof, and in which are shown by way of illustration specific embodiments in which the invention, as claimed, may be practiced. This invention may, however, be embodied in many different forms and should not be construed as limited to the embodiments set forth; rather, these embodiments are provided so that this disclosure will be thorough and complete, and will fully convey the scope of the invention to those skilled in the art. Like numbered elements refer to like elements throughout. As will be appreciated by one of skill in the art, the present invention may be embodied in methods, systems and devices. Accordingly, the present invention may take the form of an entirely hardware embodiment, or an embodiment combining software and hardware aspects.

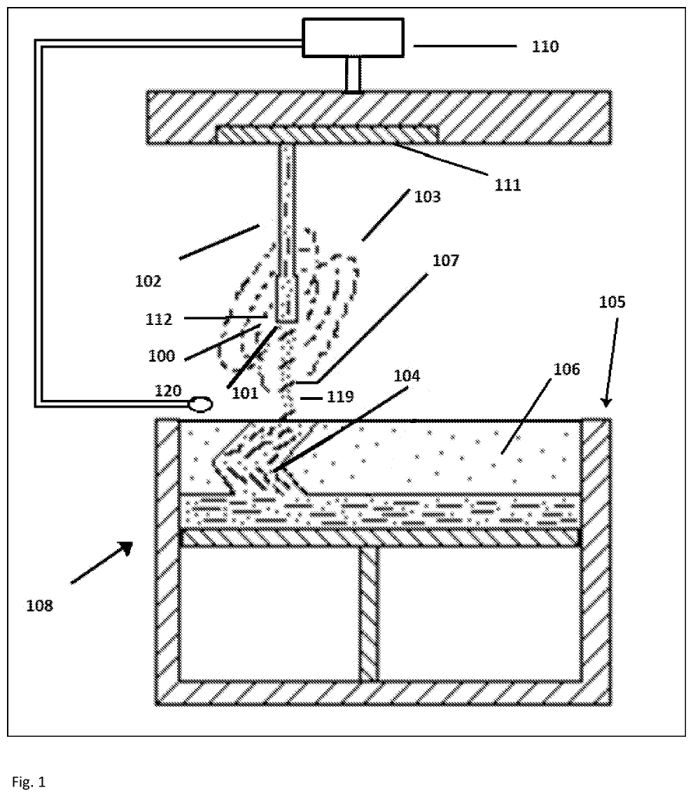

FIG. 1 shows an embodiment of an additive manufacturing apparatus or cell 108 according to the present invention. Additive manufacturing cell 108 includes one or more deposition head nozzles 101 suspended from a multi-axis positioning assembly 111 above a worktable 105. In this embodiment, a worktable 105 contains a bed of base additive material 106, such as a metallic or ceramic powder or some combination thereof, as may be conventionally used in additive manufacturing processes. Deposition head nozzles 101 are fed from storage and dispensing compartments (not illustrated), and direct a stream of enhanced additive material 119 toward the bed of base additive material 106 propelled by a gas jet or fluid. As will be described in more detail below, enhanced additive material 119 includes a mixture of both the base additive material 106 and a number of property enhancing magnetic fibers 107. Deposition head nozzles 101 direct the stream of enhanced additive material 119 toward the bed of base additive material 106. In one embodiment, property enhancing magnetic fibers 107 may be pre-mixed with the base additive material 106 and the mixture held in a single storage and dispensing compartment. In other embodiments (not illustrated), the base additive material 106 and property enhancing magnetic fibers 107 may be stored in separate or partitioned storage and dispensing compartments and mixed prior to being emitted from a single deposition head nozzle 101, or may be emitted from separate deposition head nozzles 101 and mixed after they are emitted from the deposition head nozzles 101.

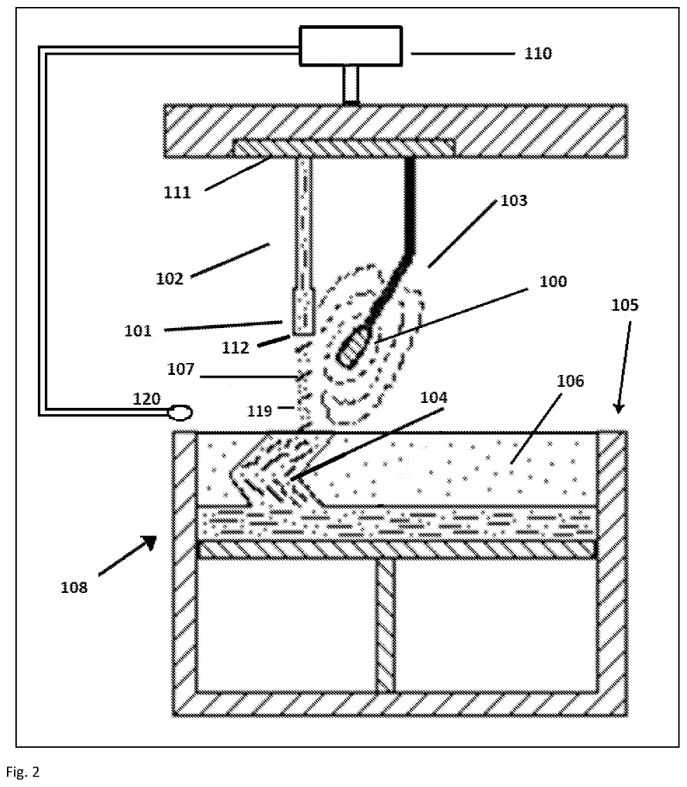

As shown in FIGS. 1 and 2, additive manufacturing cell 108 also includes an electromagnetic beam 112 such as a laser, or an electron beam, that is co-located with the one or more deposition head nozzles 101. Electromagnetic beam 112 is focused and aimed at predetermined points in the bed of base additive material 106 on the worktable 105 to selectively fuse or sinter the enhanced additive material 119 after it has been propelled from nozzle 101 and deposited on the worktable 105 in the bed of base additive material 106. Base additive material 106 in this embodiment comprises a non-magnetic metallic or a ceramic powder or a combination thereof, which is capable of being fused or sintered by electromagnetic beam 112. In alternative embodiments, additive material 106 may comprise a thermo-plastic that is heated and extruded from deposition head nozzle 101 as would be familiar to those of skill in the art. In other alternative embodiments (not illustrated herein), additive material 106 may comprise a liquid polymer deposited, fused or cross-linked, with or without the use of an electromagnetic beam, as would be familiar to those of skill in the art.

Enhanced additive material 119 is thus comprised of unfused base additive material 106 and property-enhancing magnetic fibers 107 that are selectively oriented, deposited and fused as described above on worktable 105. While the embodiments illustrated contemplate positioning assembly 111 will be moveable in multiple axes over the worktable 105, in alternative embodiments, worktable 105 may be movable so as to position the bed of base additive material 106 beneath the positioning assembly 111 in the additive manufacturing process.

The orientation of property enhancing magnetic fibers 107 with respect to the shape of the part to be manufactured is a key factor in providing optimal property enhancement of magnetic fibers 107 in the resultant part. The orientation of property enhancing magnetic fibers 107 during deposition may be controlled by a magnetic field 103 emitted from a magnetic alignment head 100. In one embodiment, the magnetic alignment head 100 is comprised of one or more electromagnets integrated with deposition head nozzle 101. In this embodiment, magnetic alignment head 100 is selectively energized by a controller 110 to control the deposition process according to the present invention. Controller 110 modulates the direction and intensity of the magnetic field 103 in order to orient the property enhancing magnetic fibers 107 in a predetermined three-dimensional orientation as the property enhancing magnetic fibers 107 exit deposition head nozzle 101. In an alternative embodiment, illustrated in FIG. 2, magnetic alignment head 100 is a separate component from deposition nozzle head 101 and is positioned to orient the property enhancing magnetic fibers 107 after they have been deposited into the bed of base additive material 106 but before they have been fused.

Controller 110 preferably operates as a closed loop feedback controller that determines the change in position of the property enhancing magnetic fibers 107 under the influence of magnetic field 103 and modulates the field accordingly to achieve a desired fiber orientation. A feedback control signal for controller 110 may be derived from one or more sensors 120 such as hall-effect, photo-electric, electro-optical, infrared, capacitive, inductive sensors, or a combination thereof, positioned in proximity to the stream of property enhancing magnetic fibers 107 to determine their orientation during the deposition process.

As noted above, magnetic alignment head 100 is used to orient the property enhancing magnetic fibers 107. In the embodiment illustrated in FIG. 1, magnetic alignment head 100 is co-axially located around the deposition head nozzle 101. While in some embodiments property enhancing magnetic fibers 107 may be emitted from one or more deposition nozzle heads 101 without the addition of base additive material 106, such as by depositing a layer composed solely of property enhancing magnetic fibers 107, typically both property enhancing magnetic fibers 107 and base additive material 106 will be emitted and deposited and fused together.

Referring still to FIG. 1, a representative section of a component being additively manufactured is shown with the property enhancing magnetic fibers 107 aligned by the magnetic alignment head 100 in a direction to enhance the strength of the fused additive material. In this example, the varying orientation of property enhancing magnetic fibers 107 corresponds to the contour of the component.

Property enhancing magnetic fibers 107 are selected and oriented as described below to enhance the strength or other properties of the base additive material 106. In alternative embodiments, property enhancing magnetic fibers 107 may be used to modify or enhance the flexibility, ductility, malleability, or other material properties of the base additive material 106. Such alterations may be localized to correspond to a continuously varying gradient or a set of discrete layers depending on the design specifications for a particular material.

FIG. 2 shows an alternative embodiment according to the present invention that provides a more flexible orientation of a magnetic field 103 independent of the position of deposition head nozzle 101. This is accomplished by employing a magnetic alignment head 100 that is not coaxially located with nozzle 101 and that may be positioned in multiple axes. The magnetic field 103 may be oriented electronically or by moving a positionable magnetic alignment head 100 in order to direct and control the position, density and orientation of property enhancing magnetic fibers 107 at a specified manufacturing step to orient and embed the property enhancing magnetic fibers 107. Property enhancing magnetic fibers 107 have been chosen to enhance specific material properties, throughout the part, internally to the part, or only on its surface, or to facilitate the joining of parts in the course of the basic additive material deposition process.

Property enhancing magnetic fibers 107 are chosen to enhance specific material or assembly enabling properties, in an additive manufacturing substrate material according to an embodiment of the present invention in the course of the basic additive material deposition process. The property enhancing magnetic fibers 107 are embedded into the stream of the base additive material 106 as described below.

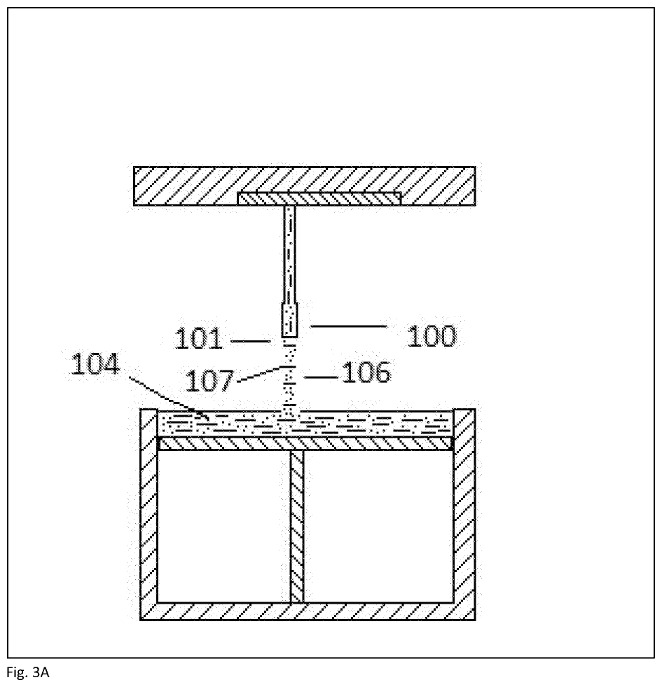

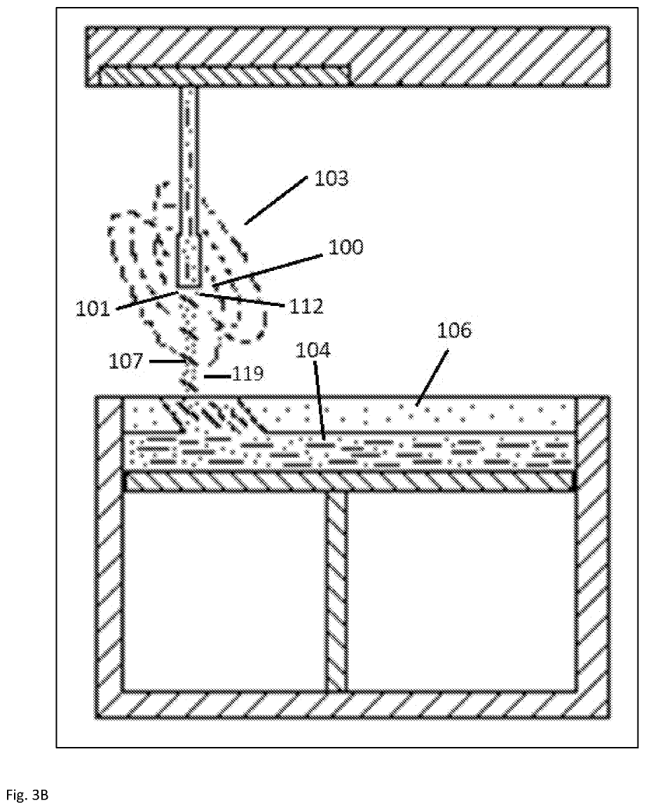

FIG. 3A shows a first process step of an embodiment according to the present invention. In this step, a stream of base additive material 106 emitted from nozzle 101 together with property enhancing magnetic fibers 107, which have been horizontally oriented by magnetic alignment head 100, to form a consolidated stream. Although FIG. 3A shows property enhancing magnetic fibers 107 in a horizontal orientation with respect to the stream of additive material, property enhancing magnetic fibers 107 may be embedded in any orientation as desired for the property enhancement needed for the specific application.

In FIG. 3B, the orientation of property enhancing magnetic fibers 107 in the base additive material 106 has been directed by magnetic alignment head 100 to be positioned at a predetermined orientation. In this specific example, it is desired that the initial fibers be aligned in the plane of additive manufactured part 104 but subsequent fibers have been aligned to conform to the changing shape of the component. For example, structural properties may be enhanced by aligning one or more layers of property enhancing magnetic fibers 107 in base additive material 106 to follow the contours of an additively manufactured part 104.

In FIG. 3C, additional layers of streamed base additive material 106 continue to be applied, but to improve material properties in the extended portion of the component being manufactured, the property enhancing magnetic fibers 107 are magnetically oriented in a different angular orientation from the layer shown in FIG. 3B to align with a change in contour of an additively manufactured part.

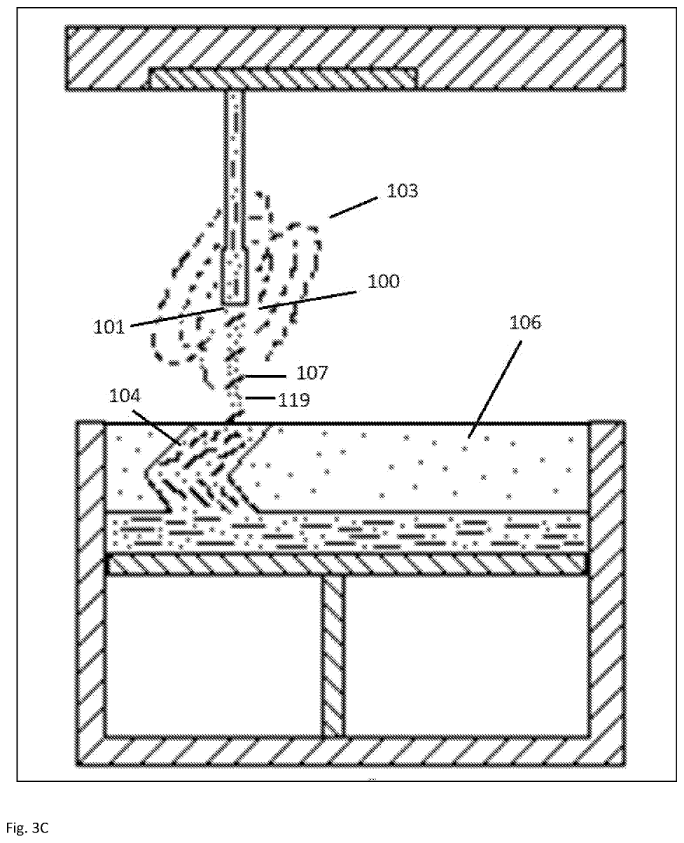

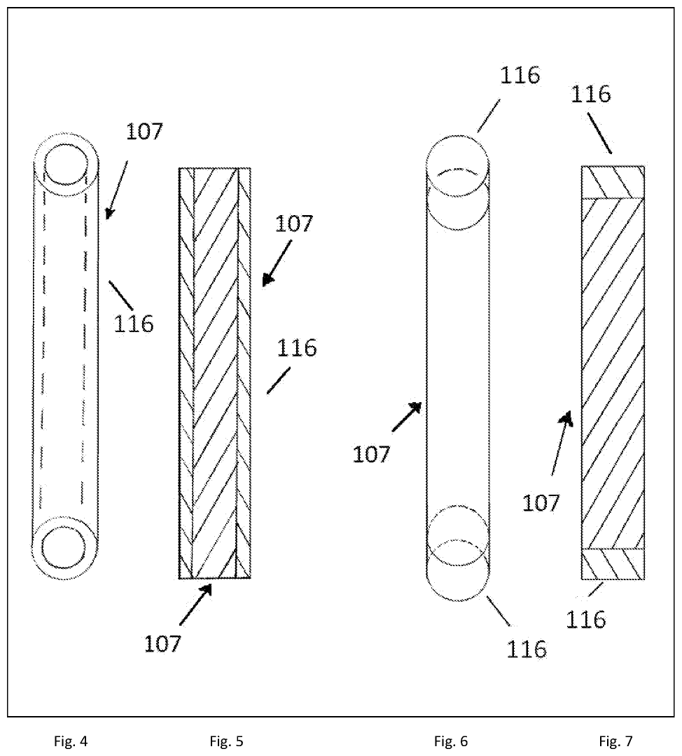

FIGS. 4-7 show two differing configurations of property enhancing magnetic fibers 107 that have been doped or coated with a magnetic material 116 to enable orientation of the property enhancing magnetic fibers 107 under the influence of an external magnetic field. FIGS. 4 and 5 show isometric and sectional views, respectively, of the magnetic material 116 applied circumferentially around fibers 107. FIGS. 6 and 7 show isometric and sectional views, respectively, of the magnetic material 116 applied to the ends of the fibers 107 only. It should be noted that the fibers need not be necessarily of a circular cross-section. The material used in fibers 107 themselves (without the addition of the magnetic material 116), as well as their specific size, shape, and cross-section may be selected to suit the property enhancing or joining purposes requirements at hand for the basic additive manufactured component and its basic substrate materials. Depending on the requirement, several different fiber configurations and types could be utilized at different phases within the complete additive manufacture of a single component for different property enhancements at different locations throughout the component in question.

In one embodiment according to the present invention, the base additive material 106 may be applied in layers and fused by heating via electromagnetic beam 112 in order to create a melt pool of metal, ceramic, or plastic into which additional base additive material bed 106 may be added to form a three-dimensional object. In an alternative embodiment, electromagnetic beam 112 may be used to sinter layers of base additive material 106 to a previously deposited layer of a three-dimensional additive manufactured part 104. In still other embodiments according to the invention, electromagnetic beam 112 may be used to harden or crosslink a liquid photopolymeric material contained on the worktable 105 to form a solid three-dimensional object. For example, the additive material can be a container of liquid ultraviolet curable photopolymer “resin” that is selectively cured by application of an ultraviolet laser.

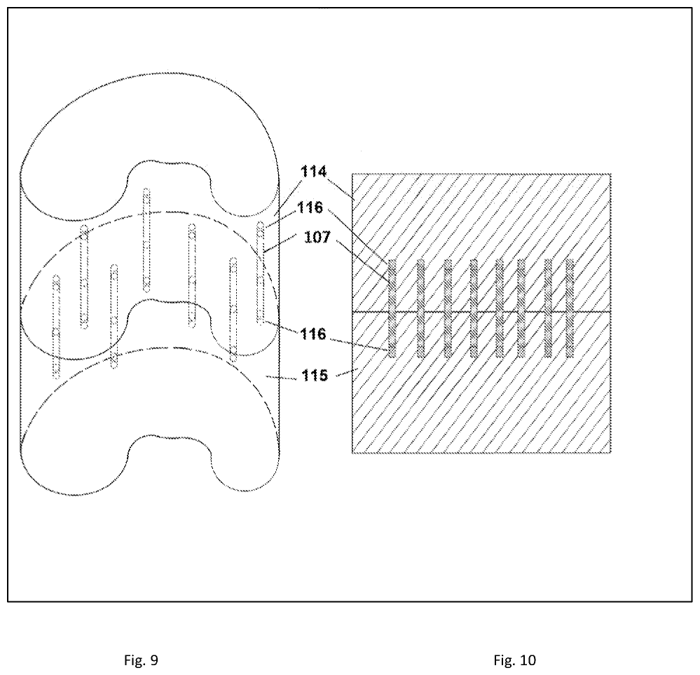

As noted, there may be structural discontinuities or weaknesses in the materials deposited in the three-dimensional layering processes described above. These weaknesses may exist at interfaces between layers of additive materials and/or may be inherent in the materials that are most commonly used in additive manufacturing processes. In addition, it might be preferable to enhance the properties of an object created using additive manufacturing techniques, with materials that although amenable to additive manufacturing assembly techniques might create compromises in terms of strength or other desirable properties along specific orientations of specific portions of the end object. Also, it may be useful in certain applications to use layers of completely different materials in the additive process, and to connect them mechanically via means amenable to and part of the additive process itself. In some cases, property-enhancement and mechanical-connection of differing additive materials might be desired. The use of selectively oriented and embedded fibers can allow this, as shown in FIG. 9 and FIG. 10.

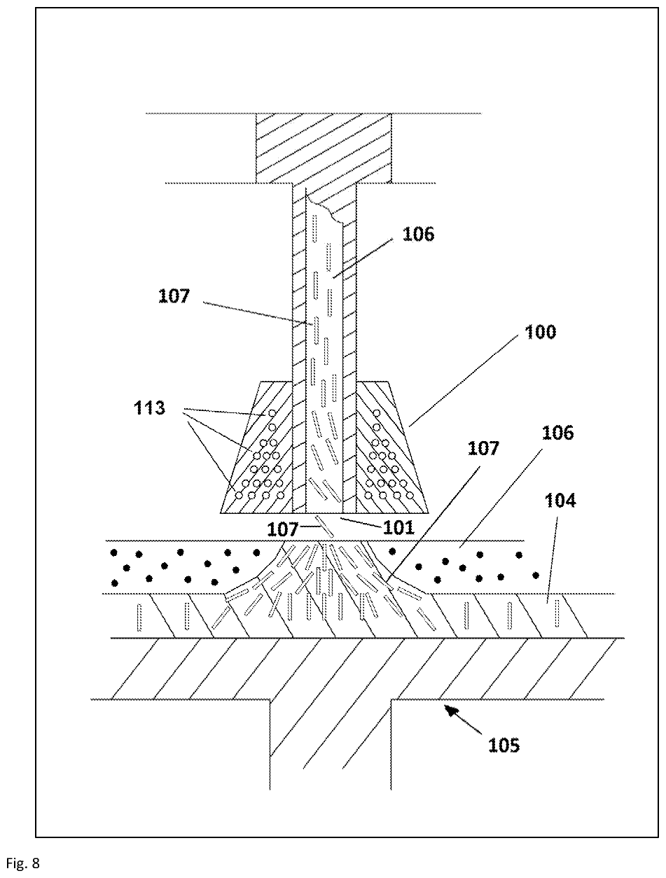

FIG. 8 shows a more detailed sectional view of the embodiment in FIG. 1 according to the present invention in which the magnetic alignment head 100 includes an electromagnetic coil assembly 113 coaxially located around the deposition head nozzle 101. Electromagnetic coil assembly 113 may be energized to effect directional and strength changes in the magnetic alignment field 103 as shown in FIGS. 1 and 2 without requiring rotation of the magnetic-alignment-head itself. FIG. 8 also shows the orientation of property enhancing magnetic fibers 107 as they exit deposition nozzle 101 have been aligned by the magnetic field from electromagnet coil assembly 113 to conform to the shape of an additive manufactured part 104 formed in the base additive material 106.

In certain embodiments according to the present invention where fusion or sintering of base additive material 106 required takes place at high temperatures, the use of magnetic material 116 with a relatively higher curie point will allow for the magnetic positioning of the fibers to take place during high-temperature additive processes.

The orientation and distribution of the fibrous material will affect the properties of the material. The strength of a material to which a unidirectional array of fibers has been added will generally be highly directionally dependent or anisotropic. In the case of additive manufacturing, anisotropic properties of directionally dependent fibers can be used to great advantage by controlling the orientation and distribution of the fibers on a layer by layer basis. For example, in embodiments where fibers are desired to add strength to a material, it will be advantageous to be able to control the orientation, distribution and density of the fibrous material on a layer by layer basis, extending from one layer through others, to effect a three-dimensional distribution and orientation of fiber. In some applications, a homogeneous distribution with random orientation of the fibrous material in one or more dimensions may be preferred. In others, a gradient in the distribution and/or orientation of the fibrous material in one or more dimensions may be used to reinforce the material or otherwise enhance the material properties of the object being manufactured via additive techniques. Other material properties desired in the end component, including modifying electromagnetic transmissivity and/or conductivity, can be enhanced by depositing appropriate fibers in a likewise manner. The concept may also be used to provide a means of structurally attaching, by internal means through the embedding, via this process described within this application, of a fiber matrix between layers of materials, two differing additive manufacturing materials that might otherwise be incompatible with each other in terms of forming an acceptable bond between them as in FIG. 9 and FIG. 10. As an example, one portion of a component could be created using ceramic or plastic material, and use transition fibers embedded by using the process herein described to form a suitable strong and continuous transition to the remainder of the end component created using a metallic or other type material. A particular advantage of this application is the creation of an end component with multiple constituent materials of potentially varying shapes and contours in a continuous, singular, additive manufacturing process flow within a single additive manufacturing cell without compromising the desired structural properties of the final end component.

In order to accomplish a change in position, orientation, or density of fibrous material added to the underlying matrix material the fibrous material may be infused or doped with a magnetic material so that the fibrous material will experience a magnetic torque in the presence of an external magnetic field that will cause it to become aligned with the external field and become drawn in the direction of increasing magnetic field. In alternative embodiments according to the present invention, the magnetic material may be coated on to the fibrous material about the fiber circumferentially as in FIG. 4 and FIG. 5 or on the ends of the fibers as in FIG. 6 and FIG. 7. In this way, during the deposition or extrusion process of the primary material utilized during the additive process, the orientation and distribution of the magnetic fibrous material may be controlled in three-dimensions. This technique will also allow the variance of the spatial distribution of such fibers, similarly or dissimilarly oriented according to application, to provide a gradient of property enhancement throughout the end component cross-section, as desired for the specific end item application.

Embodiments according to the present invention preferably employ materials as coatings or dopants that are strongly magnetic compared to the magnetic susceptibility of the material or materials forming the ductile matrix in which the strengthening fibers are to be embedded.

The strength of the external magnetic field will, in general, depend on the type of magnetic material used in doping/coating the fibrous reinforcing material, the size of the fibers and the viscosity of the ductile matrix in which the fibers are embedded. In one example, a ferromagnetic material, such as an iron or a cobalt or an alloy thereof, may be bonded or doped to the matrix lattice of the fibrous reinforcing material to effect a magnetization of the fibrous reinforcing material so that it will be attracted or repelled by the force of an external magnetic field. The process of bonding the magnetic material to the fibrous material will vary depending on the selection of materials. In some examples, bonding will occur naturally between the two materials. In other examples, an intermediate bonding agent or a combination thereof may need to be placed between the fiberous and magnetic materials.

In one example according to the present invention, the magnetic field 103 may be selectively applied by energizing an electromagnetic head 100 positioned near the work table 105 in close proximity to the additive material deposition head nozzle 101. The field strength and orientation of the magnetic field 103 may be varied, or kept constant, in space, time, or both. For example, the field strength and direction of magnetic field 103 may be kept constant in space and time to effect movement of the fibrous material. Alternatively, strength of the magnetic field 103 may be changed with position but held constant over time. In another alternative, a rotating magnetic field in which the direction changes with time may be employed to orient the deposited fibers in a circular, spiral, or helical pattern. The field emitted by magnetic head 103 may be oriented and directed by moving the magnetic head 100. Alternatively, the field may be electronically directed or deflected. For example, an array of magnetic heads may be positioned around worktable 105 and the field strength of each head adjusted to effect movement of the fibrous material. The magnetic alignment-head deposition head nozzle 101 might be co-located with (as shown in FIG. 1 and FIG. 2), or separate from (not shown), the primary additive material deposition head nozzle, depending on the choice of the primary additive material and its fusion time and other additive manufacturing control characteristics, as shown in FIG. 1 and FIG. 2.

Advantageously, methods according to the present invention enable the orientation of property enhancing magnetic fibers 107 to be changed from layer to layer. Additionally, employing methods according to the present invention, property enhancing magnetic fibers 107 may be distributed uniformly from layer to layer throughout the material or may be distributed according to a gradient.

In one embodiment according to the invention, property enhancing magnetic fibers 107 are doped with a magnetic cobalt alloy or another high curie point magnetic material, relative to the melting point of the primary additive manufacturing material, to ensure magnetically induced orientation of the reinforcement fibers is maintained through the embedding process in a high-temperature additive manufacturing environment, where such temperatures are needed for the successful use of the specific primary additive manufacturing material in question.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for additive manufacturing of a fiber enhanced composite object, comprising:
depositing a plurality of magnetically alignable fibers with an additive manufacturing base material onto a substrate to form a layer of fiber enhanced composite;
providing a magnetic field source to align the magnetically alignable fibers in a predetermined three dimensional orientation in the additive manufacturing base material to enhance a physical property of the fiber-enhanced composite; and
fusing the magnetically aligned fibers and the additive manufacturing base material to the substrate.

2. The method according to claim 1, wherein depositing a plurality of magnetically alignable fibers comprises forming a spatial variation in the density of the fibers along one or more axes in the additive manufacturing base material.

3. The method according to claim 1, wherein the predetermined orientation of the fibers compensates for a structural weakness in the object.

4. The method according to claim 3, wherein the structural weakness comprises a structural weakness at an interface between layers of dissimilar base materials applied during the additive manufacturing process.

5. The method according to claim 1, wherein fusing the magnetically aligned fibers and the additive manufacturing base material to the substrate comprises the use of a thermoplastic material.

6. The method according to claim 1, wherein fusing the magnetically aligned fibers and additive manufacturing base material to the substrate comprises the use of a metal powder.

7. The method according to claim 1, wherein the magnetically alignable fibers comprise a non-magnetic fibrous material to which a magnetic material has been bonded.

8. The method according to claim 7, wherein the magnetically alignable fibers comprise an elongate structural fiber; and
a magnetic material bonded to the elongate structural fiber wherein the fiber may be aligned by application of an external magnetic field, and wherein the magnetic material has a curie point that is greater than the melting point of the additive manufacturing base material.

9. An apparatus for depositing an additive manufacturing material comprising a plurality of magnetically alignable fibers, the apparatus comprising:
an additive manufacturing deposition head positioned over a worktable to deposit layers of additive manufacturing material on a substrate;
a magnetic alignment head positioned over the worktable and oriented to provide a magnetic field to align the magnetically alignable fibers in a predetermined three-dimensional orientation in the layers of additive manufacturing material; and
a controller for modulating the magnetic field to effect the predetermined alignment of the magnetically alignable fibers in the layer of additive manufacturing material.

10. The apparatus of claim 9 wherein the controller comprises a feedback control circuit.

11. The apparatus of claim 10 wherein the feedback control circuit comprises a sensor to determine the orientation of magnetically alignable fibers and provides information to the feedback control circuit to correct the fiber orientation during the fiber deposition process.
